(19) United States
(12) Patent Application Publication
(10) Pub. No.: US 2022/0160119 A1
(43) Pub. Date: May 26, 2022

(54) U-SHAPED ELECTRIC TOOTHBRUSH

(71) Applicant: DONGGUAN JINGHENG ELECTRONIC TECHNOLOGY CO., LTD., Weifang City (CN)

(72) Inventor: Qiao HUAJING, Weifang City (CN)

(73) Assignee: DONGGUAN JINGHENG ELECTRONIC TECHNOLOGY CO., LTD., Weifang City (CN)

(21) Appl. No.: 17/138,659

(22) Filed: Dec. 30, 2020

(30) Foreign Application Priority Data
Nov. 25, 2020 (CN) 202022770882.3

(51) Int. Cl. A46B 9/04; A46B 13/02; A46B 9/02; A61C 17/34

(52) U.S. Cl. CPC A46B 9/045; A46B 13/023; A61C 17/3481; A61C 17/3472; A46B 2200/1066; A46B 9/026

(57) ABSTRACT

The utility model discloses a U-shaped electric toothbrush. The U-shaped electric toothbrush includes a handle and a U-shaped brush head. The U-shaped brush head includes an inner brush piece and an outer brush piece separated from each other. Bristles are provided on opposite surfaces of the inner brush piece and the outer brush piece. A driving device configured to drive the inner brush piece and the outer brush piece to move in a reciprocating and alternating manner is provided on the handle. The driving device includes a motor, a connecting rod, a connecting sleeve sheathed on the connecting rod, and a gear set. The motor drives, through the gear set, the connecting rod and the connecting sleeve to move in a reciprocating and alternating manner in a radial direction of the connecting rod. The outer brush piece is connected to an upper end of the connecting sleeve and is drivable to move by the connecting sleeve. An upper end of the connecting rod passes through the connecting sleeve and protrudes upward. The inner brush piece is connected to the upper end of the connecting rod and is drivable to move by the connecting rod. According to the utility model, the inner brush piece and the outer brush piece are drivable to move in a reciprocating and alternating manner in upward and downward directions in an oral cavity to clean teeth with the bristles. Therefore, the amplitude of motion of the bristles is increased, cleaning efficiency is improved, and the time spent by a user on tooth brushing is shortened.

### BACKGROUND OF THE INVENTION

### Field of the Invention

The utility model relates to the technical field of toothbrushes, and in particular, to a U-shaped electric toothbrush.

### Description of the Prior Art

In order to keep dental health, people need to brush teeth every day with toothbrushes. Toothbrushes are generally classified into a traditional manual toothbrush and an electric toothbrush. Cleaning teeth through vibration of a brush head, an existing electric toothbrush makes the teeth cleaner and is more convenient to use compared to a manual toothbrush. Although the existing electric toothbrush brings great convenience to people's life, the following problems still exist during actual use. During tooth brushing through vibration, bristles have a relatively small amplitude of vibration, which makes it difficult to achieve a best cleaning effect, results in low cleaning efficiency, increases the time for tooth brushing, and leads to poor user experience.

### SUMMARY OF THE INVENTION

The utility model provides a U-shaped electric toothbrush to address deficiencies in the prior art. The U-shaped electric toothbrush can increase cleaning efficiency of electric toothbrushes, reduce the time for cleaning, and improve user experience.

In order to achieve the above objectives, the utility model adopts the following technical solutions.

A U-shaped electric toothbrush includes a handle and a U-shaped brush head, the U-shaped brush head including an inner brush piece and an outer brush piece separated from each other, bristles being provided on both opposite surfaces of the inner brush piece and the outer brush piece, and a driving device configured to drive the inner brush piece and the outer brush piece to move in a reciprocating and alternating manner being provided on the handle, the driving device including a motor, a connecting rod, a connecting sleeve sheathed on the connecting rod, and a gear set, the motor driving, through the gear set, the connecting rod and the connecting sleeve to move in a reciprocating and alternating manner in a radial direction of the connecting rod, the outer brush piece being connected to an upper end of the connecting sleeve and being drivable to move by the connecting sleeve, an upper end of the connecting rod passing through the connecting sleeve and protruding upward, and the inner brush piece being connected to the upper end of the connecting rod and being drivable to move by the connecting rod.

As a preferred solution, a first connecting member is provided at the upper end of the connecting sleeve, and a lower end of the outer brush piece is wrapped around an outer side of the first connecting member upon assembly.

As a preferred solution, the first connecting member has first connecting arms that are arc-shaped and extend toward two sides.

As a preferred solution, a second connecting member is provided at the upper end of the connecting rod, and a lower end of the inner brush piece is wrapped around an outer side of the second connecting member upon assembly.

As a preferred solution, the second connecting member has second connecting arms that are arc-shaped and extend toward two sides.

As a preferred solution, the gear set includes a driving gear, a first double gear, a second double gear, a third double gear, a first driven gear, and a second driven gear, the first double gear, the second double gear, and the third double gear each having a large gear ring at a lower end and a small gear ring at an upper end, the driving gear being connected to an output shaft of the motor, the large gear ring of the first double gear meshing with the driving gear, the large gear ring of the second double gear meshing with the small gear ring of the first double gear, the large gear ring of the third double gear meshing with the small gear ring of the second double gear, the first driven gear and the second driven gear respectively meshing with the small ring gear of the third double gear, a first cam rotating with the first driven gear being provided at an upper end of the first driven gear, a first driving arm protruding radially outward being provided on the connecting sleeve, a first driving hole mating with the first cam being provided on the first driving arm, the first cam being embedded in the first driving hole and being capable of driving the first driving arm to move, a second cam rotating with the second driven gear being provided at an upper end of the second driven gear, a second driving arm protruding radially outward being provided on the connecting rod, a second driving hole mating with the second cam being provided on the second driving arm, and the second cam being embedded in the second driving hole and being capable of driving the second driving arm to move.

As a preferred solution, the first driving arm and the second driving arm are configured to protrude in different directions.

As a preferred solution, the U-shaped electric toothbrush further includes a gear box configured to accommodate the gear set, the gear box including an upper box body and a lower box body, the upper box body being provided with a first through hole for the output shaft of the motor to pass through, and the upper box body being provided with a second through hole for the connecting sleeve to pass through.

The utility model has apparent advantages and beneficial effects compared with the prior art. Specifically, the U-shaped brush head is divided into the inner brush piece and the outer brush piece, and the driving device configured to drive the inner brush piece and the outer brush piece to move in a reciprocating and alternating manner is provided on the handle, so that during tooth brushing, the inner brush piece and the outer brush piece are drivable to move in a reciprocating and alternating manner in upward and downward directions in an oral cavity to clean teeth with the bristles. Therefore, the amplitude of motion of the bristles is increased, cleaning efficiency is improved, the time spent by a user on tooth brushing is shortened, and user experience is enhanced. In addition, the reciprocating and alternating driving of the inner brush piece and the outer brush piece can be achieved through mere cooperation of the connecting rod and the connecting sleeve, so that an overall volume of the U-shaped toothbrush is reduced, thus increasing the brushing efficiency.

In order to describe structural features, technical means, specific purposes and functions of the utility model more clearly, the utility model is described in further detail below with reference to the accompanying drawings and specific embodiments.

### BRIEF DESCRIPTION OF THE DRAWINGS

FIG. 1 is a schematic diagram of an assembled structure according to an embodiment of the utility model.

FIG. 2 is a schematic diagram of a disassembled structure according to an embodiment of the utility model.

FIG. 3 is a schematic diagram of a disassembled structure of a driving device according to an embodiment of the utility model.

FIG. 4 is a schematic enlarged view of A in FIG. 3.

### DESCRIPTION OF REFERENCE NUMERALS

| | | |
|---|---|---|
| 10. U-shaped brush head | 11. Outer brush piece | 12. Inner brush piece |
| 13. Bristle | 20. Driving device | 21. Motor |
| 211. Driving gear | 22. Gear box | 221. Lower |
| | | box body |
| 222. Upper box body | 23. Connecting sleeve | 231. First connecting |
| | | member |
| 232. First driving arm | 24. Connecting rod | 241. Second connecting |
| | | member |
| 242. Second driving arm | 25. First double gear | 26. Second double |
| | | gear |
| 27. Third double gear | 28. First driven gear | 281. First cam |
| 29. Second driven gear | 291. Second cam. | |

### DETAILED DESCRIPTION

In the description of the utility model, it is to be noted that orientation or position relationships indicted by terms such as “center”, “upper”, “lower”, “left”, “right”, “vertical”, “horizontal”, “inner”, “outer” are based on orientation or position relationships shown in the accompanying drawings, are merely for facilitating the description of the utility model and simplify the description, instead of indicating or implying that the indicated position or element needs to have particular orientations or be constructed and operated in particular orientations, and therefore cannot be construed as a limitation on the utility model.

In the description of the present invention, it should be noted that unless otherwise explicitly specified or defined, the terms such as “mount”, “install”, “connect”, and “connection” should be understood in a broad sense. For example, the connection may be a fixed connection, a detachable connection, or an integral connection; or the connection may be a mechanical connection or an electrical connection; or the connection may be a direct connection, an indirect connection through an intermediary, or internal communication between two components. A person of ordinary skill in the art can understand specific meanings of the terms in the utility model according to specific situations.

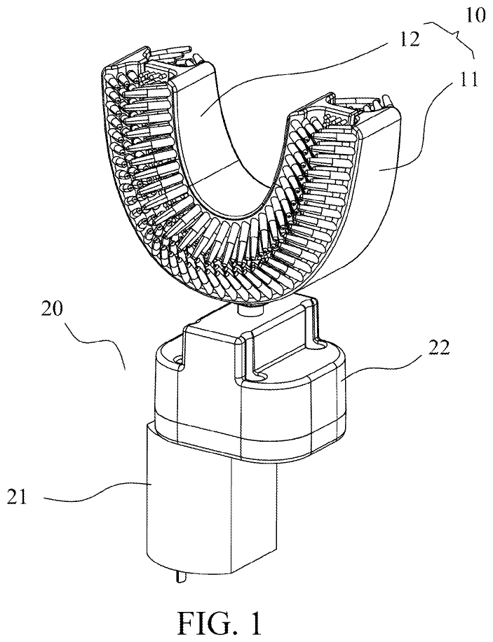

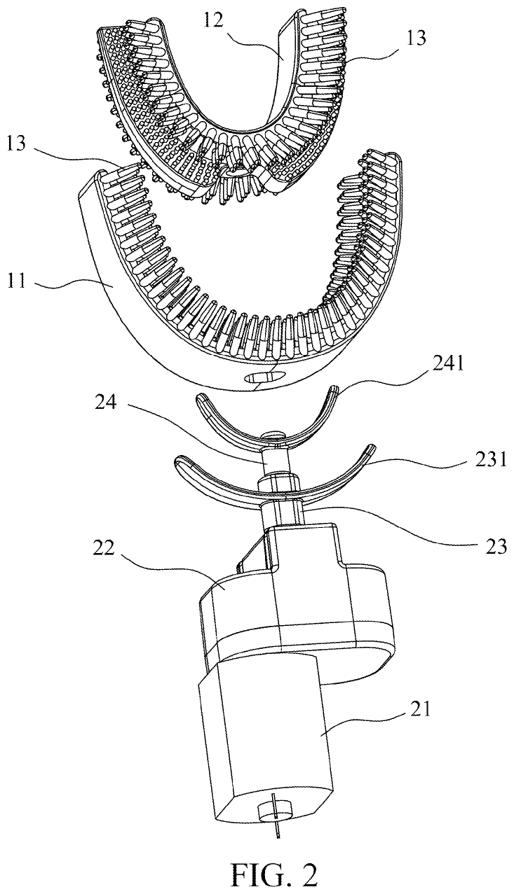

As shown in FIG. 1 to FIG. 4, a U-shaped electric toothbrush includes a handle and a U-shaped brush head 10. The U-shaped brush head 10 includes an inner brush piece 12 and an outer brush piece 11 separated from each other. Bristles 13 are provided on both opposite surfaces of the inner brush piece 12 and the outer brush piece 11, and a driving device 20 configured to drive the inner brush piece 12 and the outer brush piece 11 to move in a reciprocating and alternating manner is provided on the handle. The driving device 20 includes a motor 21, a connecting rod 24, a connecting sleeve 23 sheathed on the connecting rod 24, a gear set, and a gear box 22 configured to accommodate the gear set. The motor 21 drives, through the gear set, the connecting rod 24 and the connecting sleeve 23 to move in a reciprocating and alternating manner in a radial direction of the connecting rod 24. The outer brush piece 11 is connected to an upper end of the connecting sleeve 23 and is drivable to move by the connecting sleeve 23. An upper end of the connecting rod 24 passes through the connecting sleeve 23 and protrudes upward, and the inner brush piece 12 is connected to the upper end of the connecting rod 24 and is drivable to move by the connecting rod 24. The gear box 22 includes an upper box body 222 and a lower box body 221. The upper box body 222 is provided with a first through hole for an output shaft of the motor 21 to pass through, and the upper box body 222 is provided with a second through hole for the connecting sleeve 23 to pass through. During tooth brushing, the motor 21 drives, through the gear set, the connecting rod 24 and the connecting sleeve 23 to move in a reciprocating and alternating manner in the radial direction of the connecting rod 24, and the connecting rod 24 and the connecting sleeve 23 respectively drive the inner brush piece 12 and the outer brush piece 11 to move in a reciprocating and alternating manner in upward and downward directions in an oral cavity, thus cleaning teeth.

Specifically, a first connecting member 231 is provided at the upper end of the connecting sleeve 23, and a lower end of the outer brush piece 11 is wrapped around an outer side of the first connecting member 231 upon assembly. A second connecting member 241 is provided at the upper end of the connecting rod 24, and a lower end of the inner brush piece 12 is wrapped around an outer side of the second connecting member 241 upon assembly. The first connecting member 231 has first connecting arms that are arc-shaped and extend toward two sides, and the second connecting member 241 has second connecting arms that are arc-shaped and extend toward two sides. By disposing the first connecting member 231 and the second connecting member 241, the connection between the outer brush piece 11 and the inner brush piece 12 is more stable, thus increasing a service life of the electric toothbrush. In the utility model, the first connecting member 231 is detachably sheathed on an outer side of the upper end of the connecting sleeve 23, and the second connecting member 241 is detachably sheathed on an outer side of the upper end of the connecting rod 24.

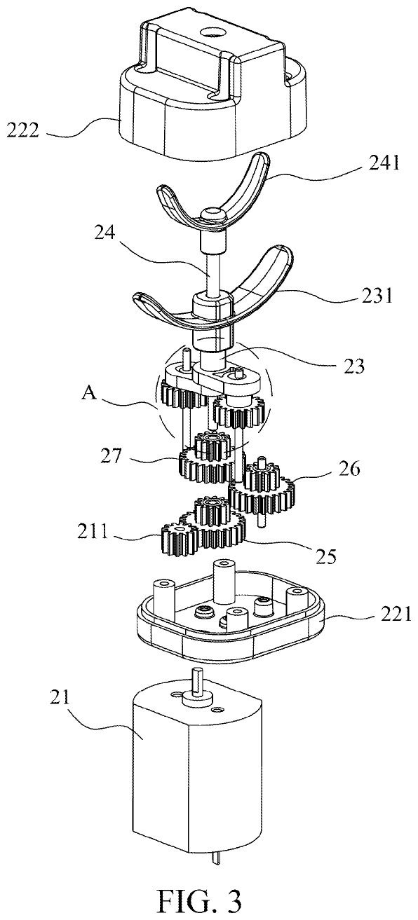

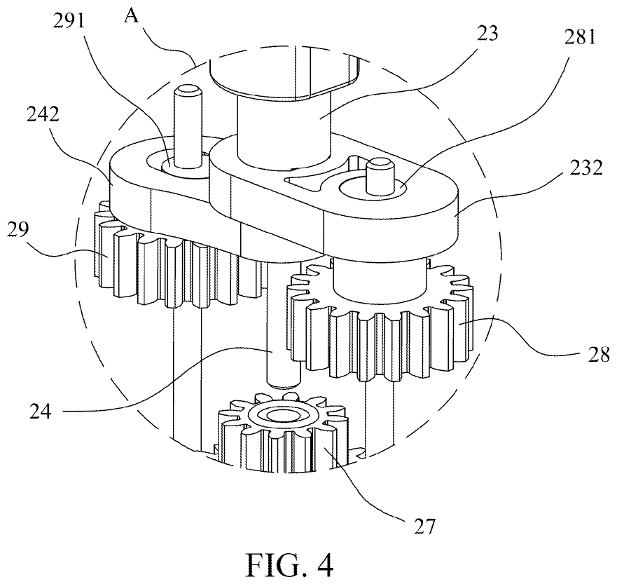

As shown in FIG. 3 and FIG. 4, the gear set includes a driving gear 211, a first double gear 25, a second double gear 26, a third double gear 27, a first driven gear 28, and a second driven gear 29. The first double gear 25, the second double gear 26, and the third double gear 27 each have a large gear ring at a lower end and a small gear ring at an upper end, and the driving gear 211 is connected to an output shaft of the motor 21. The large gear ring of the first double gear 25 meshes with the driving gear 211, the large gear ring of the second double gear 26 meshes with the small gear ring of the first double gear 25, and the large gear ring of the third double gear 27 meshes with the small gear ring of the second double gear 26. The first driven gear 28 and the second driven gear 29 respectively mesh with the small ring gear of the third double gear 27. A first cam 281 rotating with the first driven gear 28 is provided at an upper end of the first driven gear 28, a first driving arm 232 protruding radially outward is provided on the connecting sleeve 23, and a first driving hole mating with the first cam 281 is provided on the first driving arm 232. The first cam 281 is embedded in the first driving hole and is capable of driving the first driving arm 232 to move. A second cam 291 rotating with the second driven gear 29 is provided at an upper end of the second driven gear 29, a second driving arm 242 protruding radially outward is provided on the connecting rod 24, and a second driving hole mating with the second cam 291 is provided on the second driving arm 242. The second cam 291 is embedded in the second driving hole and is capable of driving the second driving arm 242 to move. Specifically, the first driving arm 232 and the second driving arm 242 are configured to protrude in different directions. In this embodiment, the first driving arm 232 and the second driving arm 242 respectively protrude along the U-shaped brush head on upper and lower sides of the oral cavity. The U-shaped electric toothbrush further includes a control module configured to control operating gears, so that different vibration amplitudes may be selected as required during tooth brushing.

Based on the above, in the utility model, the U-shaped brush head is divided into the inner brush piece and the outer brush piece, and the driving device configured to drive the inner brush piece and the outer brush piece to move in a reciprocating and alternating manner is disposed on the handle, so that the inner brush piece and the outer brush piece are drivable to move in a reciprocating and alternating in upward and downward directions in the oral cavity to clean teeth with the bristles. Therefore, the amplitude of motion of the bristles is increased, cleaning efficiency is improved, the time spent by a user on tooth brushing is shortened, and user experience is enhanced. In addition, the reciprocating and alternating driving of the inner brush piece and the outer brush piece can be achieved through mere cooperation of the connecting rod and the connecting sleeve, so that an overall volume of the U-shaped toothbrush is reduced, thus increasing the brushing efficiency.

The above description is merely preferred embodiments of the utility model, and is not intended to limit the utility model. Therefore, any modification, equivalent replacement, and improvement actually made to the above embodiments according to the technology of the utility model still fall within the scope of the technical solutions of the utility model.

1. A U-shaped electric toothbrush, comprising a handle and a U-shaped brush head, wherein the U-shaped brush head comprises an inner brush piece and an outer brush piece separated from each other, bristles being provided on opposite surfaces of the inner brush piece and the outer brush piece, a driving device configured to drive the inner brush piece and the outer brush piece to move in a reciprocating and alternating manner being provided on the handle, the driving device comprising a motor, a connecting rod, a connecting sleeve sheathed on the connecting rod, and a gear set, the motor driving, through the gear set, the connecting rod and the connecting sleeve to move in a reciprocating and alternating manner in a radial direction of the connecting rod, the outer brush piece being connected to an upper end of the connecting sleeve and being drivable to move by the connecting sleeve, an upper end of the connecting rod passing through the connecting sleeve and protruding upward, and the inner brush piece being connected to the upper end of the connecting rod and being drivable to move by the connecting rod.

2. The U-shaped electric toothbrush according to claim 1, wherein a first connecting member is provided at the upper end of the connecting sleeve, and a lower end of the outer brush piece is wrapped around an outer side of the first connecting member upon assembly.

3. The U-shaped electric toothbrush according to claim 2, wherein the first connecting member has first connecting arms that are arc-shaped and extend toward two sides.

4. The U-shaped electric toothbrush according to claim 1, wherein a second connecting member is provided at the upper end of the connecting rod, and a lower end of the inner brush piece is wrapped around an outer side of the second connecting member upon assembly.

5. The U-shaped electric toothbrush according to claim 4, wherein the second connecting member has second connecting arms that are arc-shaped and extend toward two sides.

6. The U-shaped electric toothbrush according to claim 1, wherein the gear set comprises a driving gear, a first double gear, a second double gear, a third double gear, a first driven gear, and a second driven gear, the first double gear, the second double gear, and the third double gear each having a large gear ring at a lower end and a small gear ring at an upper end, the driving gear being connected to an output shaft of the motor, the large gear ring of the first double gear meshing with the driving gear, the large gear ring of the second double gear meshing with the small gear ring of the first double gear, the large gear ring of the third double gear meshing with the small gear ring of the second double gear, the first driven gear and the second driven gear respectively meshing with the small ring gear of the third double gear, a first cam rotating with the first driven gear being provided at an upper end of the first driven gear, a first driving arm protruding radially outward being provided on the connecting sleeve, a first driving hole mating with the first cam being provided on the first driving arm, the first cam being embedded in the first driving hole and being capable of driving the first driving arm to move, a second cam rotating with the second driven gear being provided at an upper end of the second driven gear, a second driving arm protruding radially outward being provided on the connecting rod, a second driving hole mating with the second cam being provided on the second driving arm, and the second cam being embedded in the second driving hole and being capable of driving the second driving arm to move.

7. The U-shaped electric toothbrush according to claim 6, wherein the first driving arm and the second driving arm are configured to protrude in different directions.

8. The U-shaped electric toothbrush according to claim 6, further comprising: a gear box configured to accommodate the gear set, the gear box comprising an upper box body and a lower box body, the upper box body being provided with a first through hole for the output shaft of the motor to pass through, and the upper box body being provided with a second through hole for the connecting sleeve to pass through.
